(19) United States
(12) Patent Application Publication
(10) Pub. No.: US 2026/0219980 A1
(43) Pub. Date: Jul. 30, 2026

(54) MACHINE LEARNING-BASED DETECTION AND REMEDIATION OF LATENCY-RELATED PERFORMANCE ISSUES IN STORAGE SYSTEMS

(71) Applicant: Dell Products L.P., Round Rock, TX (US)

(72) Inventors: Sumanta Kashyapi, Redmond, WA (US); Ramesh Doddaiah, Westborough, MA (US); Michael Barnes, Doylestown, PA (US); David C. Sydow, Merrimack, NH (US); Robert Duncan Harper, Ipswich (GB); Shreyans Jasoriya, New Haven, CT (US)

(21) Appl. No.: 19/041,075

(22) Filed: Jan. 30, 2025

(51) Int. Cl. G06F 11/07; G06F 11/30

(52) U.S. Cl. CPC G06F 11/079; G06F 11/0727; G06F 11/0781; G06F 11/0793

(57) ABSTRACT

An apparatus comprises at least one processing device configured to obtain monitoring data for a storage system including telemetry data for a set of metrics including a latency metric and additional metrics. The at least one processing device is also configured to determine metric-specific anomalous data points utilizing machine learning-based univariate anomaly detectors, and to determine metric-generic anomalous data points utilizing a machine learning-based multivariate anomaly detector. The at least one processing device is further configured to identify a given metric-specific anomalous data point for the latency metric which corresponds to one of the metric-generic anomalous data points, and to determine whether the given metric-specific anomalous data point for the latency metric represents a performance issue for the storage system based on whether there are any co-occurring metric-specific anomalous data points for the additional metrics, and to initiate remediation of the performance issue responsive to this determination.

### BACKGROUND

Storage arrays and other types of storage systems are often shared by multiple host devices over a network. Applications running on the host devices each include one or more processes that perform the application functionality. Such processes issue input-output (IO) operation requests for delivery to the storage systems. Storage controllers of the storage systems service such requests for IO operations. In some information processing systems, multiple storage systems may be used to form a storage cluster.

### SUMMARY

Illustrative embodiments of the present disclosure provide techniques for machine learning-based detection and remediation of latency-related performance issues in storage systems.

In one embodiment, an apparatus comprises at least one processing device comprising a processor coupled to a memory. The at least one processing device is configured to obtain monitoring data for a storage system, the monitoring data comprising telemetry data for a set of two or more metrics, the set of two or more metrics including a latency metric and one or more additional metrics. The at least one processing device is also configured to determine, for each metric in the set of two or more metrics, one or more metric-specific anomalous data points utilizing a machine learning-based univariate anomaly detector trained utilizing historical telemetry data for that metric, and to determine, for the set of two or more metrics collectively, one or more metric-generic anomalous data points utilizing a machine learning-based multivariate anomaly detector trained to identify structural anomalies across the set of two or more metrics. The at least one processing device is further configured to identify a given one of the one or more metric-specific anomalous data points for the latency metric which corresponds to one of the one or more metric-generic anomalous data points, and to determine whether the given metric-specific anomalous data point for the latency metric represents a performance issue for the storage system based at least in part on whether there are any co-occurring metric-specific anomalous data points for at least one of the one or more additional metrics. The at least one processing device is further configured, responsive to determining that the given metric-specific anomalous data point for the latency metric represents a performance issue for the storage system, to initiate remediation of the performance issue for the storage system.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based detection and remediation of latency-related performance issues in storage systems in an illustrative embodiment.

FIG. 2 is a flow diagram of an exemplary process for machine learning-based detection and remediation of latency-related performance issues in storage systems in an illustrative embodiment.

FIG. 3 shows a set of issue descriptions for performance-based issues affecting latency in storage systems in an illustrative embodiment.

FIG. 4 shows a system configured for detection of performance-based issues affecting latency in storage systems in an illustrative embodiment.

FIG. 5 shows a set of plots for latency and other metrics collected from a storage system in an illustrative embodiment.

FIG. 6 shows another set of plots for latency and other metrics collected from a storage system in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

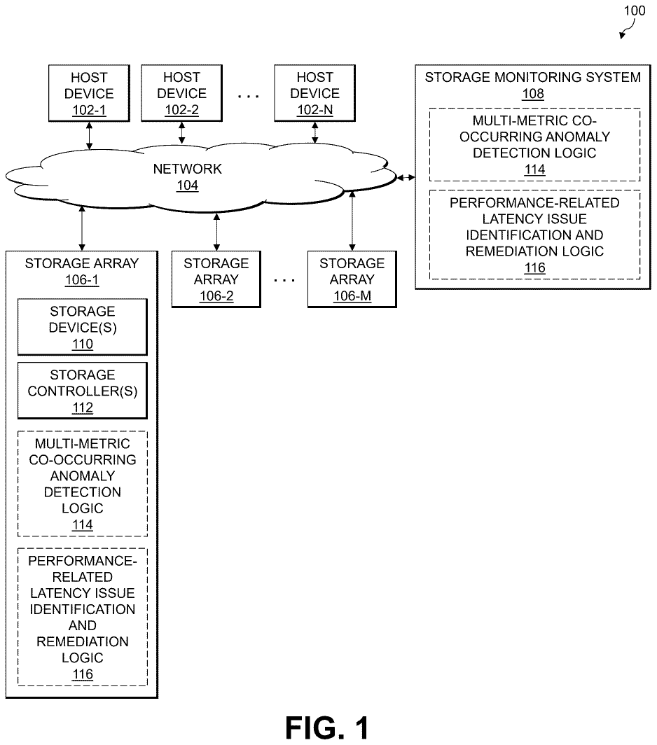

FIG. 1 shows an information processing system 100 configured in accordance with an illustrative embodiment to provide functionality for machine learning-based detection and remediation of latency-related performance issues in storage systems. The information processing system 100 comprises one or more host devices 102-1, 102-2,. 102-N (collectively, host devices 102) that communicate over a network 104 with one or more storage arrays 106-1, 106-2,. 106-M (collectively, storage arrays 106). The network 104 may comprise a storage area network (SAN). Also coupled to the network 104 is a storage monitoring system 108, which may be configured to provide monitoring services for one or more of the storage arrays 106.

The storage array 106-1, as shown in FIG. 1, comprises a plurality of storage devices 110 each storing data utilized by one or more applications running on the host devices 102. The storage devices 110 are illustratively arranged in one or more storage pools. The storage array 106-1 also comprises one or more storage controllers 112 that facilitate IO processing for the storage devices 110. The storage array 106-1 and its associated storage devices 110 are an example of what is more generally referred to herein as a “storage system.” This storage system in the present embodiment is shared by the host devices 102, and is therefore also referred to herein as a “shared storage system.” In embodiments where there is only a single host device 102, the host device 102 may be configured to have exclusive use of the storage system. In some embodiments, the storage arrays 106 may be part of a storage cluster (e.g., where the storage arrays 106 may be used to implement one or more storage nodes in a cluster storage system comprising a plurality of storage nodes interconnected by one or more networks), and the host devices 102 are assumed to submit IO operations to be processed by the storage cluster.

The host devices 102 illustratively comprise respective computers, servers or other types of processing devices capable of communicating with the storage arrays 106 via the network 104. For example, at least a subset of the host devices 102 may be implemented as respective virtual machines of a compute services platform or other type of processing platform. The host devices 102 in such an arrangement illustratively provide compute services such as execution of one or more applications on behalf of each of one or more users associated with respective ones of the host devices 102.

The term “user” herein is intended to be broadly construed so as to encompass numerous arrangements of human, hardware, software or firmware entities, as well as combinations of such entities.

Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The storage devices 110 of the storage array 106-1 may implement logical units (LUNs) configured to store objects for users associated with the host devices 102. These objects can comprise files, blocks or other types of objects. The host devices 102 interact with the storage array 106-1 utilizing read and write commands as well as other types of commands that are transmitted over the network 104. Such commands in some embodiments more particularly comprise Small Computer System Interface (SCSI) commands, although other types of commands can be used in other embodiments. A given IO operation as that term is broadly used herein illustratively comprises one or more such commands. References herein to terms such as “input-output” and “IO” should be understood to refer to input and/or output. Thus, an IO operation relates to at least one of input and output.

Also, the term “storage device” as used herein is intended to be broadly construed, so as to encompass, for example, a logical storage device such as a LUN or other logical storage volume. A logical storage device can be defined in the storage array 106-1 to include different portions of one or more physical storage devices. Storage devices 110 may therefore be viewed as comprising respective LUNs or other logical storage volumes.

The storage devices 110 of the storage array 106-1 can be implemented using solid state drives (SSDs). Such SSDs are implemented using non-volatile memory (NVM) devices such as flash memory. Other types of NVM devices that can be used to implement at least a portion of the storage devices 110 include non-volatile random-access memory (NVRAM), phase-change RAM (PC-RAM) and magnetic RAM (MRAM). These and various combinations of multiple different types of NVM devices or other storage devices may also be used. For example, hard disk drives (HDDs) can be used in combination with or in place of SSDs or other types of NVM devices. Accordingly, numerous other types of electronic or magnetic media can be used in implementing at least a subset of the storage devices 110.

In some embodiments, the storage arrays 106 in the FIG. 1 embodiment provide or implement multiple distinct storage tiers of a multi-tier storage system. By way of example, a given multi-tier storage system may comprise a fast tier or performance tier implemented using flash storage devices or other types of SSDs, and a capacity tier implemented using HDDs, possibly with one or more such tiers being server based. A wide variety of other types of storage devices and multi-tier storage systems can be used in other embodiments, as will be apparent to those skilled in the art. The particular storage devices used in a given storage tier may be varied depending on the particular needs of a given embodiment, and multiple distinct storage device types may be used within a single storage tier. As indicated previously, the term “storage device” as used herein is intended to be broadly construed, and so may encompass, for example, SSDs, HDDs, flash drives, hybrid drives or other types of storage products and devices, or portions thereof, and illustratively include logical storage devices such as LUNs.

It should be appreciated that a multi-tier storage system may include more than two storage tiers, such as one or more “performance” tiers and one or more “capacity” tiers, where the performance tiers illustratively provide increased IO performance characteristics relative to the capacity tiers and the capacity tiers are illustratively implemented using relatively lower cost storage than the performance tiers. There may also be multiple performance tiers, each providing a different level of service or performance as desired, or multiple capacity tiers.

At least one of the storage controllers of the storage arrays 106 (e.g., the storage controller 112 of storage array 106-1) is assumed to implement functionality for machine learning-based detection and remediation of latency-related performance issues for its associated one of the storage arrays 106. Such functionality is provided via multi-metric co-occurring anomaly detection logic 114 and performance-related latency issue identification and remediation logic 116 implemented by the storage array 106-1. In other embodiments, the multi-metric co-occurring anomaly detection logic 114 and the performance-related latency issue identification and remediation logic 116 may be implemented on the storage monitoring system 108. In still other embodiments, the functionality for machine learning-based detection and remediation of latency-related performance issues may be implemented at least in part on one or more of the storage arrays 106 and on the storage monitoring system 108. Thus, as shown in FIG. 1, the multi-metric co-occurring anomaly detection logic 114 and the performance-related latency issue identification and remediation logic 116 are shown in dashed outline in both the storage array 106-1 and the storage monitoring system 108. Although not shown in FIG. 1, other ones of the storage arrays 106-2 through 106-M may be configured with storage devices and storage controllers, and may implement instances of the multi-metric co-occurring anomaly detection logic 114 and the performance-related latency issue identification and remediation logic 116.

The multi-metric co-occurring anomaly detection logic 114 is configured to analyze telemetry data for a latency metric and one or more additional metrics (e.g., IO size, bandwidth, input-output operations per second (IOPS), counts of read and/or write operations, etc.) to determine co-occurring anomalies (e.g., where spikes or other anomalies for the latency metric are correlated with spikes or other anomalies in one or more other ones of the metrics). This may include performing univariate anomaly detection for the latency and other metrics individually, as well as performing multivariate anomaly detection for the latency and other metrics collectively. The performance-related latency issue identification and remediation logic 116 is configured to filter out such co-occurring anomalies (e.g., which represent latency anomalies that are “false positives” attributable to other behavior in the storage arrays 106) to determine true performance-related latency issues (e.g., where latency anomalies are not correlated with anomalies for other metrics). The performance-related latency issue identification and remediation logic 116 is further configured to remediate such performance-related latency issues (e.g., which may include diagnosing or performing root cause analysis, and applying fixes to the storage arrays 106 based on such diagnosis or the results of the root cause analysis).

Although in the FIG. 1 embodiment the multi-metric co-occurring anomaly detection logic 114 and the performance-related latency issue identification and remediation logic 116 are shown as being implemented internal to the storage array 106-1 and outside the storage controllers 112, in other embodiments one or both of the multi-metric co-occurring anomaly detection logic 114 and the performance-related latency issue identification and remediation logic 116 may be implemented at least partially internal to the storage controllers 112 or at least partially outside the storage array 106-1, such as on the storage monitoring system 108, on one of the host devices 102, on one or more other ones of the storage arrays 106-2 through 106-M, on one or more servers external to the host devices 102 and the storage arrays 106 (e.g., including on a cloud computing platform or other type of information technology (IT) infrastructure), etc.

At least portions of the functionality of the multi-metric co-occurring anomaly detection logic 114 and the performance-related latency issue identification and remediation logic 116 may be implemented at least in part in the form of software that is stored in memory and executed by a processor.

The host devices 102, the storage arrays 106 and the storage monitoring system 108 in the FIG. 1 embodiment are assumed to be implemented using at least one processing platform, with each processing platform comprising one or more processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The host devices 102, the storage arrays 106 and the storage monitoring system 108 may be implemented on respective distinct processing platforms, although numerous other arrangements are possible. For example, in some embodiments at least portions of one or more of the host devices 102, one or more of the storage arrays 106 and/or the storage monitoring system 108 are implemented on the same processing platform. One or more of the storage arrays 106 can therefore be implemented at least in part within at least one processing platform that implements at least a subset of the host devices 102 and/or the storage monitoring system 108.

The network 104 may be implemented using multiple networks of different types to interconnect storage system components. For example, the network 104 may comprise a SAN that is a portion of a global computer network such as the Internet, although other types of networks can be part of the SAN, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Although in some embodiments certain commands used by the host devices 102 to communicate with the storage arrays 106 illustratively comprise SCSI commands, other types of commands and command formats can be used in other embodiments. For example, some embodiments can implement IO operations utilizing command features and functionality associated with NVM Express (NVMe), as described in the NVMe Specification, Revision 1.3, May 2017, which is incorporated by reference herein. Other storage protocols of this type that may be utilized in illustrative embodiments disclosed herein include NVMe over Fabric, also referred to as NVMeoF, and NVMe over Transmission Control Protocol (TCP), also referred to as NVMe/TCP.

The storage array 106-1 in the present embodiment is assumed to comprise a persistent memory that is implemented using a flash memory or other type of non-volatile memory of the storage array 106-1. More particular examples include NAND-based flash memory or other types of non-volatile memory such as resistive RAM, phase change memory, and spin torque transfer magneto-resistive RAM (STT-MRAM). The persistent memory is further assumed to be separate from the storage devices 110 of the storage array 106-1, although in other embodiments the persistent memory may be implemented as a designated portion or portions of one or more of the storage devices 110. For example, in some embodiments the storage devices 110 may comprise flash-based storage devices, as in embodiments involving all-flash storage arrays, or may be implemented in whole or in part using other types of non-volatile memory.

As mentioned above, communications between the host devices 102 and the storage arrays 106 may utilize PCIe connections or other types of connections implemented over one or more networks. For example, illustrative embodiments can use interfaces such as Internet SCSI (iSCSI), Serial Attached SCSI (SAS) and Serial ATA (SATA). Numerous other interfaces and associated communication protocols can be used in other embodiments.

The storage arrays 106 in some embodiments may be implemented as part of a cloud-based system. The storage monitoring system 108 may also or alternatively be implemented as part of the cloud-based system.

It should therefore be apparent that the term “storage array” as used herein is intended to be broadly construed, and may encompass multiple distinct instances of a commercially-available storage array.

Other types of storage products that can be used in implementing a given storage system in illustrative embodiments include software-defined storage, cloud storage, object-based storage and scale-out storage. Combinations of multiple ones of these and other storage types can also be used in implementing a given storage system in an illustrative embodiment.

In some embodiments, a storage system comprises first and second storage arrays arranged in an active-active configuration. For example, such an arrangement can be used to ensure that data stored in one of the storage arrays is replicated to the other one of the storage arrays utilizing a synchronous replication process. Such data replication across the multiple storage arrays can be used to facilitate failure recovery in the system 100. One of the storage arrays may therefore operate as a production storage array relative to the other storage array which operates as a backup or recovery storage array.

It is to be appreciated, however, that embodiments disclosed herein are not limited to active-active configurations or any other particular storage system arrangements. Accordingly, illustrative embodiments herein can be configured using a wide variety of other arrangements, including, by way of example, active-passive arrangements, active-active Asymmetric Logical Unit Access (ALUA) arrangements, and other types of ALUA arrangements.

These and other storage systems can be part of what is more generally referred to herein as a processing platform comprising one or more processing devices each comprising a processor coupled to a memory. A given such processing device may correspond to one or more virtual machines or other types of virtualization infrastructure such as Docker containers or other types of LXCs. As indicated above, communications between such elements of system 100 may take place over one or more networks.

The term “processing platform” as used herein is intended to be broadly construed so as to encompass, by way of illustration and without limitation, multiple sets of processing devices and one or more associated storage systems that are configured to communicate over one or more networks. For example, distributed implementations of the host devices 102 are possible, in which certain ones of the host devices 102 reside in one data center in a first geographic location while other ones of the host devices 102 reside in one or more other data centers in one or more other geographic locations that are potentially remote from the first geographic location. The storage arrays 106 and the storage monitoring system 108 may be implemented at least in part in the first geographic location, the second geographic location, and one or more other geographic locations. Thus, it is possible in some implementations of the system 100 for different ones of the host devices 102, the storage arrays 106 and the storage monitoring system 108 to reside in different data centers.

Numerous other distributed implementations of the host devices 102, the storage arrays 106 and the storage monitoring system 108 are possible. Accordingly, the host devices 102, the storage arrays 106 and the storage monitoring system 108 can also be implemented in a distributed manner across multiple data centers.

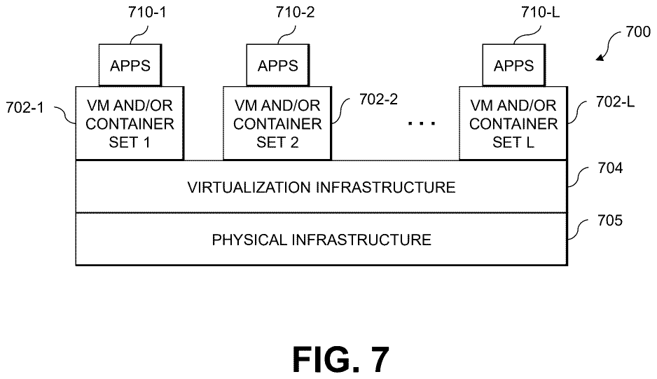

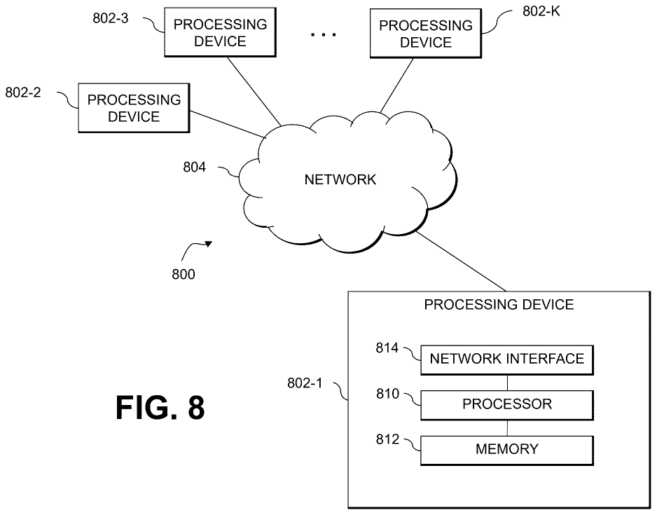

Additional examples of processing platforms utilized to implement portions of the system 100 in illustrative embodiments will be described in more detail below in conjunction with FIGS. 7 and 8.

It is to be understood that the particular set of elements shown in FIG. 1 for machine learning-based detection and remediation of latency-related performance issues in storage systems is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

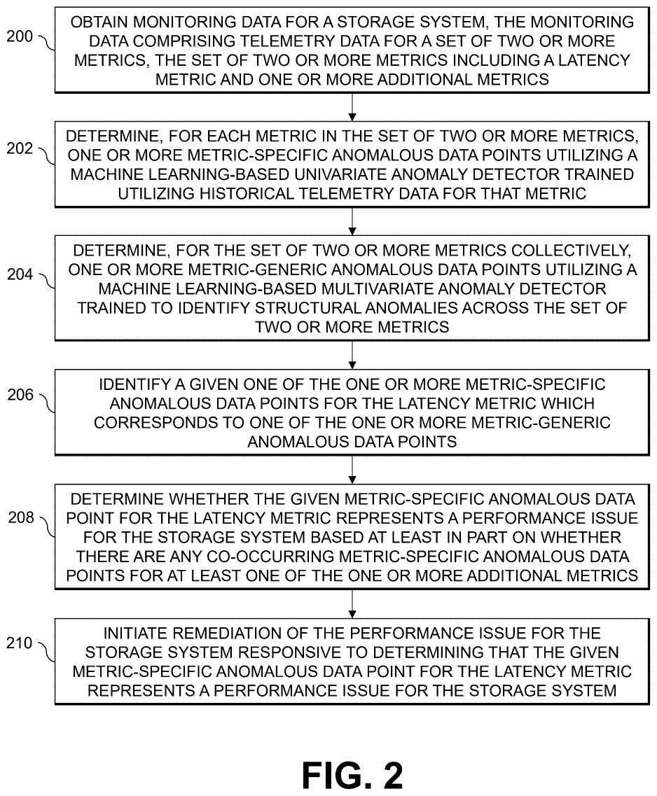

An exemplary process for machine learning-based detection and remediation of latency-related performance issues in storage systems will now be described in more detail with reference to the flow diagram of FIG. 2. It is to be understood that this particular process is only an example, and that additional or alternative processes for machine learning-based detection and remediation of latency-related performance issues in storage systems.

In this embodiment, the process includes steps 200 through 210. These steps are assumed to be performed utilizing the multi-metric co-occurring anomaly detection logic 114 and the performance-related latency issue identification and remediation logic 116. The process begins with step 200, obtaining monitoring data for a storage system, the monitoring data comprising telemetry data for a set of two or more metrics, the set of two or more metrics including a latency metric and one or more additional metrics. The one or more additional metrics may comprise at least one of an IO size metric, a bandwidth metric, an IOPS metric, a count of IO read operations, a count of IO write operations, etc.

In step 202, for each metric in the set of two or more metrics, one or more metric-specific anomalous data points are determined utilizing a machine learning-based univariate anomaly detector trained utilizing historical telemetry data for that metric. In step 204, one or more metric-generic anomalous data points for the set of two or more metrics collectively are determined utilizing a machine learning-based multivariate anomaly detector trained to identify structural anomalies across the set of two or more metrics. In some embodiments, the machine learning-based univariate anomaly detector trained utilizing the historical telemetry data for the latency metric utilizes a first machine learning anomaly detection algorithm and the machine learning-based multivariate anomaly detector utilizes a second machine learning anomaly detection algorithm, the second machine learning anomaly detection algorithm being different than the first machine learning anomaly detection algorithm. In other embodiments, the machine learning-based univariate anomaly detector trained utilizing the historical telemetry data for the latency metric and the machine learning-based multivariate anomaly detector utilize a same machine learning anomaly detection algorithm. The machine learning anomaly detection algorithm may be an Isolation Forest machine learning algorithm, a Time Series Transformer deep learning algorithm, etc.

A given one of the one or more metric-specific anomalous data points for the latency metric which corresponds to one of the one or more metric-generic anomalous data points is identified in step 206. Identifying the given metric-specific anomalous data point for the latency metric which corresponds to said one of the one or more metric-generic anomalous data points may further comprise identifying at least one additional metric-specific anomalous data point for at least one of the one or more additional metrics also corresponding to said one of the one or more metric-generic anomalous data points.

In step 208, a determination is made as to whether the given metric-specific anomalous data point for the latency metric represents a performance issue for the storage system based at least in part on whether there are any co-occurring metric-specific anomalous data points for at least one of the one or more additional metrics. Determining whether the given metric-specific anomalous data point for the latency metric represents a performance issue for the storage system may comprise generating a ranking of co-occurring metric-specific anomalous data points for the one or more additional metrics, the ranking being based on predicted impact of the one or more additional metrics on latency of the storage system, and utilizing the ranking of the co-occurring metric-specific anomalous data points for performing root cause analysis of the given metric-specific anomalous data point for the latency metric.

In step 210, remediation of the performance issue for the storage system is initiated responsive to determining that the given metric-specific anomalous data point for the latency metric represents a performance issue for the storage system. The performance issue for the storage system may comprise at least a threshold increase in the latency metric that is not correlated with at least a threshold change in an IO workload pattern of the storage system (e.g., a spike or other increase in latency which is not associated with a change in the IO workload pattern). The threshold change in the IO workload pattern of the storage system may comprise at least a threshold deviation from a seasonal IO workload pattern of the storage system. Initiating remediation of the performance issue for the storage system may comprise performing a root cause analysis for the given metric-specific anomalous data point for the latency metric, modifying a configuration of the storage system to prevent a future occurrent of the given metric-specific anomalous data point for the latency metric, etc.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Providing professional services (e.g., support services) for enterprise and other storage systems may include responding to and resolving performance-based issues in the storage systems. The initial investigation after a service request, however, often involves significant manual effort, because customers or other users submitting the service requests are typically unable to pinpoint an exact time when the performance impact began. The leads to higher service costs and longer Mean Time to Resolution (MTTR). Service experts must sift through large volumes of coarse-grained historical telemetry data to pinpoint relevant data points for detailed analysis. To address this issue, artificial intelligence (AI) and machine learning (ML) algorithms may be leveraged, including univariate anomaly detection algorithms. However, a major drawback to univariate anomaly detection algorithms is that such algorithms often fall short in capturing complex correlations between metrics.

Illustrative embodiments provide technical solutions that integrate results from both univariate and multivariate anomaly detection algorithms. Thus, the technical solutions described herein are advantageously able to streamline root cause analysis (RCA) processes for performance-related issues in storage appliances or other storage systems by identifying critical data points (e.g., representing performance-impacting latency issues) efficiently. The technical solutions described herein leverage the combined insights of univariate anomaly detection (e.g., for initial screening) and multivariate anomaly detection (e.g., for deeper, more nuanced analysis). The technical solutions described herein are thus able to provide significant improvements in efficiency and accuracy when identifying potential performance-based latency anomalies in storage systems.

When a performance-based issue affects an enterprise or other storage system, it is critical that the service team responsible for triaging and fixing the issue can quickly identify the time at which the problem began to occur and initiate a detailed investigation. Enhancing the efficiency of the servicing and triage pipeline is essential for reducing the MTTR and overall service costs.

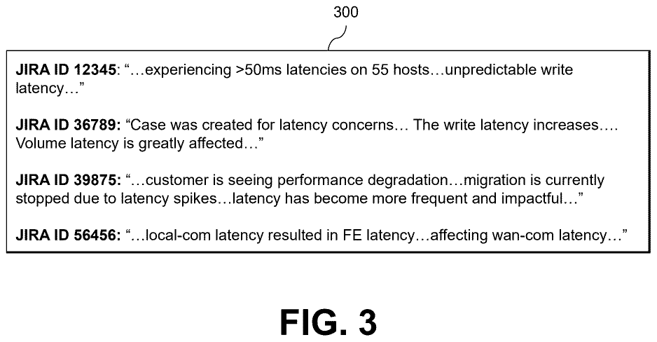

Across a range of different storage products, latency consistently emerges as a critical metric of concern, as evidenced by historical triage and service data. For example, out of over 1000 service requests documented for storage systems over a period of one year, more than half of these cases explicitly cite latency issues in their descriptions. FIG. 3 shows an example 300 of snippets of service request descriptions associated with different JIRA identifiers (IDs). In the initial stages of RCA for storage system service requests, experts extensively scrutinize historical latency metrics of affected devices. The experts focus particularly on identifying instances where latency correlates with other variables in the telemetry data, indicating pivotal time points for detailed investigation. However, this manual process demands substantial domain expertise and effort, impacting both the MTTR metric and overall customer satisfaction. The technical solutions described herein, in some embodiments, utilize an AI/ML-driven solution aimed at expediting the RCA process for performance issues in storage systems. The technical solutions described herein are advantageously able to provide faster issue resolution and improved MTTR metrics, enhancing overall service efficiency and customer satisfaction.

As discussed above, the investigation of performance-related issues primarily revolves around latency issues, which are relevant in a significant portion of service requests. Changes in correlation patterns between latency metrics and other metrics or variables (e.g., IO size, bandwidth, IOPS, counts of read and/or write IO operations, etc.) often serve as crucial indicators linking symptoms to the root causes of those issues. However, conventional approaches that rely solely on univariate anomaly detection operate independently of these correlations and thus fail to identify these structural anomalies. Such conventional approaches tend to generate numerous false positives, such as when high latency is expected under heavy workload conditions. True anomalies should only be flagged when high latency occurs independent of or without corresponding changes in workload patterns of a storage system. Moreover, structural deviations in historical telemetry data become actionable only if they are accompanied by insights into the likely metrics that may have caused the anomaly. The technical solutions described herein address these and other technical challenges, through a synergistic blend of univariate and multivariate anomaly detection techniques, complemented by insights gleaned from historical RCA documents.

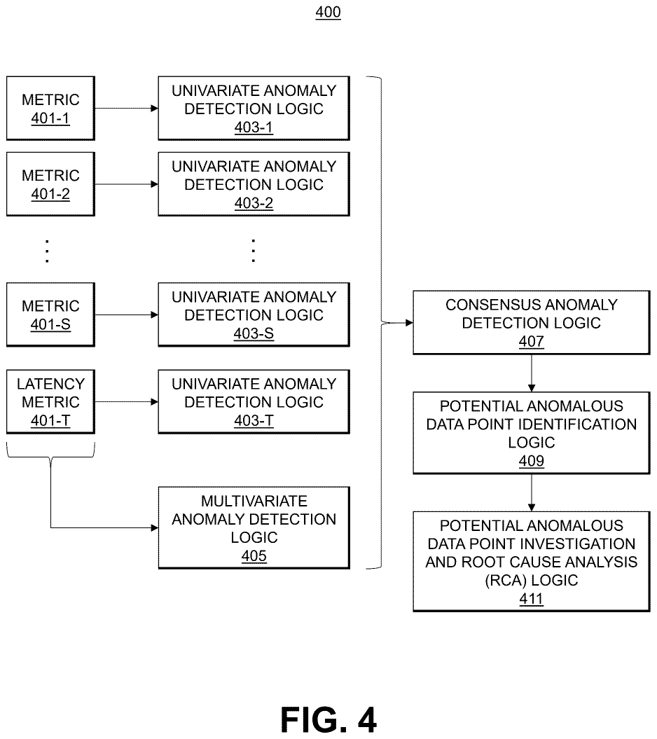

FIG. 4 shows a system 400 configured for integrating contextual understanding from univariate and multivariate analysis, together with historical knowledge, for enhancing anomaly detection accuracy thereby facilitating more effective and targeted troubleshooting of performance issues in storage systems. The system 400 includes a plurality of metrics 401-1, 401-2, . . . 401-S and a latency metric 401-T (collectively, metrics 401) which are processed utilizing respective instances of univariate anomaly detection logic 403-1, 403-2, . . . 403-S and 403-T (collectively, univariate anomaly detection logic 403), with the result being identification of anomalous data points for each of the metrics individually (e.g., where each of the metrics 401 may include a time series of values for that metric). The metrics 401-1 through 401-S may include, for example, IO size, bandwidth, IOPS, counts of read and write operations, etc. The metrics 401 are also collectively processed by multivariate anomaly detection logic 405. The outputs of the univariate anomaly detection logic 403 and the multivariate anomaly detection logic 405 are processed using the consensus anomaly detection logic 407, which is configured to finalize the output anomalies that are subject to further review. This is illustrated in the system 400 by the potential anomalous data point identification logic 409, where the output of the consensus anomaly detection logic 407 is used to identify potentially anomalous data points to be investigated using the potential anomalous data point investigation and RCA logic 411. The potential anomalous data point investigation and RCA logic 411 is configured, in some embodiments, to present the potential anomalous data points to one or more subject matter experts (SMEs) or other triage personnel, which can determine whether the any of the potential anomalous data points are “interesting” data points requiring detailed investigation and RCA. This may include, for example, analyzing time series for the metrics 401 to detect “broken” correlations among anomalies in the latency metric 401-T and other ones of the metrics 401-1 through 401-S.

In the system 400, the metrics 401 may comprise preprocessed historical telemetry data, including the latency metric 401-T, which is gathered to support retrospective analysis of performance-related disruptions in storage systems and initiate RCA processing and remediation. Each of the metrics 401 undergoes independent analysis using a respective dedicated instance of the univariate anomaly detection logic 403 (e.g., a dedicated univariate anomaly detector trained on the historical data for that metric). The multivariate anomaly detection logic 405 is configured to implement a multivariate anomaly detector that is able to identify structural anomalies across the metrics 401 collectively. The univariate and multivariate anomaly detectors may utilize various anomaly detection algorithms, including artificial intelligence (AI) and machine learning (ML) approaches. Deep learning approaches for implementing the univariate and/or multivariate anomaly detectors include, for example, Dense Autoencoder, BiLSTM Autoencoder, Variational Autoencoder, Multivariate Time-Series Anomaly Detection (MTAD) via Graph Attention Networks (MTAD-GAT), Time Series Transformers, etc. ML approaches for implementing the univariate and/or multivariate anomaly detectors include, for example, Isolation Forest, k-Nearest Neighbors (KNN), Unsupervised Outlier Detection Using Empirical Cumulative Distribution Functions (ECOD), Kernel Density Estimation (KDE) for Unsupervised Outlier Detection, Principal Component Analysis (PCA) Outlier Detector, One-Class Support Vector Machine (SVM) Detector, etc. In some embodiments, the Isolation Forest algorithm is selected as it provides a good tradeoff between accuracy in detection results and required computational resources. It should be appreciated, however, that embodiments are not limited solely to use with the Isolation Forest algorithm for implementing the univariate and/or multivariate anomaly detector. In some embodiments, different algorithms may be used for implementing different ones of the univariate anomaly detectors (e.g., for different ones of the metrics 401) and the multivariate anomaly detector.

The consensus anomaly detection logic 407 is configured to filter and retain the anomalous data points that are identified by both the univariate and multivariate anomaly detectors. The results of processing by the consensus anomaly detection logic 407 are used by the potential anomalous data point identification logic 409 to identify latency anomalies in the latency metric 401-T (e.g., representing potential performance-impacting issues or anomalous data points), which may be presented to one or more SMEs or other triage personnel, along with the co-occurring anomalies (termed “explanation anomalies”) in other relevant ones of the metrics 401-1 through 401-S. The co-occurring or explanation anomalies provide possible contributors to the latency anomaly, thereby guiding a more focused RCA investigation by the potential anomalous data point investigation and RCA logic 411.

Implementation of the technical solutions described herein will now be described with respect to sample telemetry data for sets of metrics obtained from operational storage appliances (e.g., telemetry data obtained through Dell APEX AIOps).

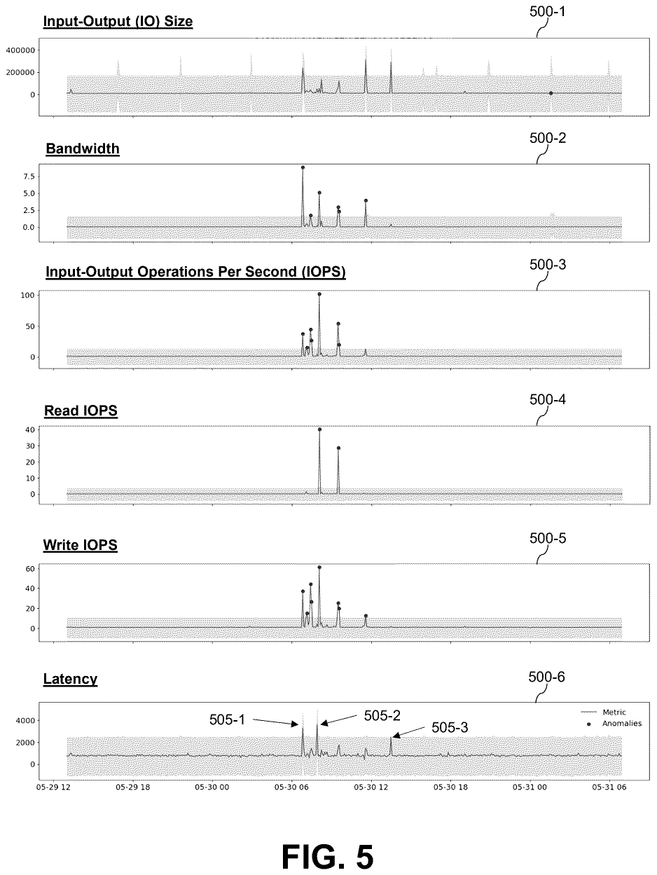

FIG. 5 shows a set of plots 500-1 through 500-6 (collectively, plots 500) for different metrics (e.g., IO size metric plot 500-1, bandwidth metric plot 500-2, IOPS metric plot 500-3, IOPS read metric plot 500-4, IOPS write metric plot 500-5 and latency metric plot 500-6). Each of the plots 500 shows a time series of its respective metric value, as well as values or data points which are flagged as anomalies (e.g., using an associated univariate anomaly detector). In this example, the telemetry data for the metrics is taken from a storage system over a 48-hour period, showing distinct changes in IO workload patterns. High latency is expected for high IO workloads, and therefore should not be flagged as anomalous. In the specific example of FIG. 5, there are data points 505-1, 505-2 and 505-3 in the latency metric plot 500-6 which a univariate anomaly detection algorithm operating alone would flag as anomalous. Employing a consensus algorithm with multivariate anomaly detection, however, prevents flagging the data points 505-1, 505-2 and 505-3 as anomalies (e.g., as these are “false positive” anomalies corresponding to co-occurring spikes or changes in the IO size metric in the IO size plot 500-1). Through understanding the correlations between different metrics, the “false positive” data points 505-1, 505-2 and 505-3 are recognized as being “normal” data points in the context of the other metrics monitored for the storage system.

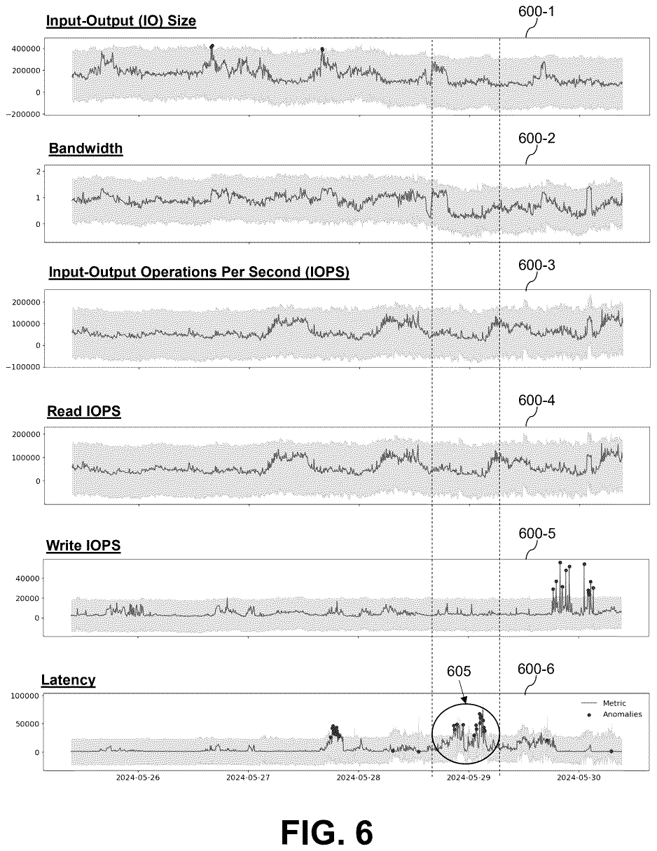

FIG. 6 shows a set of plots 600-1 through 600-6 (collectively, plots 600) for different metrics (e.g., IO size metric plot 600-1, bandwidth metric plot 600-2, IOPS metric plot 600-3, IOPS read metric plot 600-4, IOPS write metric plot 600-5 and latency metric plot 600-6). Each of the plots 600 shows a time series of its respective metric value, as well as values or data points which are flagged as anomalies (e.g., using an associated univariate anomaly detector). In this example, the telemetry data for the metrics is taken from a storage system over a four-day period. The multivariate detector and consensus algorithm flags a latency anomaly 605, which corresponds to a set of significant latency spikes without any corresponding observable changes in IO patterns (e.g., no clear deviation from seasonal IO patterns) shown in the plots 600-1 through 600-5. Subsequently, case documentation (e.g., service request description logs) is used to identify or attribute network connectivity issues as the underlying cause of the latency anomaly 605, thereby validating the accuracy in identifying non-IO related latency anomalies.

In some embodiments, an ensemble-based approach is used for detecting performance related issues in storage systems, where the ensemble approach utilizes AI/ML techniques to report potential performance-impacting latency issues (e.g., latency anomalies which are not related to IO workload changes for a storage system). In some embodiments, three univariate anomaly detectors report on latency, read IOPS count and write IOPS count, and one multivariate anomaly detector reports based on the latency, read IOPS count and write IOPS count collectively. Following this, a consensus algorithm is used to flag anomalies (e.g., anomalous latency values) detected by the univariate and multivariate anomaly detectors, with a filter to provide reporting specifically on latency issues which are detected without co-occurring anomalies in the read IOPS count or the write IOPS count. The technical solutions described herein are able to rank co-occurring anomalies based on their anticipated impact on latency anomalies.

The technical solutions described herein are advantageously able to detect performance-impacting latency anomalies (e.g., latency issues not associated with IO workload changes in a storage system) through integrating a list of co-occurring anomalies across different metrics, informed by multivariate anomaly detection conditioned on inter-metric correlations. This allows for optimizing MTTR for performance-related service requests, as a prioritized list of explanatory anomalies serves as actionable insights for SMEs, triage engineers or other personnel responsible for analysis of performance issues in storage systems. This focused approach significantly narrows down the solution space, thereby increasing the likelihood of identifying the root cause swiftly.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based detection and remediation of latency-related performance issues in storage systems will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100 in FIG. 1. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based detection and remediation of latency-related performance issues in storage systems as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, storage systems, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to obtain monitoring data for a storage system, the monitoring data comprising telemetry data for a set of two or more metrics, the set of two or more metrics including a latency metric and one or more additional metrics;
to determine, for each metric in the set of two or more metrics, one or more metric-specific anomalous data points utilizing a machine learning-based univariate anomaly detector trained utilizing historical telemetry data for that metric;
to determine, for the set of two or more metrics collectively, one or more metric-generic anomalous data points utilizing a machine learning-based multivariate anomaly detector trained to identify structural anomalies across the set of two or more metrics;
to identify a given one of the one or more metric-specific anomalous data points for the latency metric which corresponds to one of the one or more metric-generic anomalous data points;
to determine whether the given metric-specific anomalous data point for the latency metric represents a performance issue for the storage system based at least in part on whether there are any co-occurring metric-specific anomalous data points for at least one of the one or more additional metrics; and
responsive to determining that the given metric-specific anomalous data point for the latency metric represents a performance issue for the storage system, to initiate remediation of the performance issue for the storage system.

2. The apparatus of claim 1 wherein the performance issue for the storage system comprises at least a threshold increase in the latency metric that is not correlated with at least a threshold change in an input-output workload pattern of the storage system.

3. The apparatus of claim 2 wherein the threshold change in the input-output workload pattern of the storage system comprises at least a threshold deviation from a seasonal input-output workload pattern of the storage system.

4. The apparatus of claim 1 wherein the one or more additional metrics comprise at least one of an input-output size metric, a bandwidth metric, and an input-output operations per second metric.

5. The apparatus of claim 1 wherein the one or more additional metrics comprise at least one of a count of input-output read operations and a count of input-output write operations.

6. The apparatus of claim 1 wherein the machine learning-based univariate anomaly detector trained utilizing the historical telemetry data for the latency metric utilizes a first machine learning anomaly detection algorithm and the machine learning-based multivariate anomaly detector utilizes a second machine learning anomaly detection algorithm, the second machine learning anomaly detection algorithm being different than the first machine learning anomaly detection algorithm.

7. The apparatus of claim 1 wherein the machine learning-based univariate anomaly detector trained utilizing the historical telemetry data for the latency metric and the machine learning-based multivariate anomaly detector utilize a same machine learning anomaly detection algorithm.

8. The apparatus of claim 1 wherein at least one of (i) the machine learning-based univariate anomaly detector trained utilizing the historical telemetry data for the latency metric and (ii) the machine learning-based multivariate anomaly detector implements an Isolation Forest machine learning algorithm.

9. The apparatus of claim 1 wherein at least one of (i) the machine learning-based univariate anomaly detector trained utilizing the historical telemetry data for the latency metric and (ii) the machine learning-based multivariate anomaly detector implements a Time Series Transformer deep learning algorithm.

10. The apparatus of claim 1 wherein identifying the given metric-specific anomalous data point for the latency metric which corresponds to said one of the one or more metric-generic anomalous data points further comprises identifying at least one additional metric-specific anomalous data point for at least one of the one or more additional metrics also corresponding to said one of the one or more metric-generic anomalous data points.

11. The apparatus of claim 1 wherein determining whether the given metric-specific anomalous data point for the latency metric represents a performance issue for the storage system comprises generating a ranking of co-occurring metric-specific anomalous data points for the one or more additional metrics, the ranking being based on predicted impact of the one or more additional metrics on latency of the storage system.

12. The apparatus of claim 11 wherein determining whether the given metric-specific anomalous data point for the latency metric represents a performance issue for the storage system comprises utilizing the ranking of the co-occurring metric-specific anomalous data points for performing root cause analysis of the given metric-specific anomalous data point for the latency metric.

13. The apparatus of claim 1 wherein initiating remediation of the performance issue for the storage system comprises performing a root cause analysis for the given metric-specific anomalous data point for the latency metric.

14. The apparatus of claim 1 wherein initiating remediation of the performance issue for the storage system comprises modifying a configuration of the storage system to prevent a future occurrent of the given metric-specific anomalous data point for the latency metric.

15. A computer program product comprising a non-transitory processor-readable storage medium having stored therein program code of one or more software programs, wherein the program code when executed by at least one processing device causes the at least one processing device:
to obtain monitoring data for a storage system, the monitoring data comprising telemetry data for a set of two or more metrics, the set of two or more metrics including a latency metric and one or more additional metrics;
to determine, for each metric in the set of two or more metrics, one or more metric-specific anomalous data points utilizing a machine learning-based univariate anomaly detector trained utilizing historical telemetry data for that metric;
to determine, for the set of two or more metrics collectively, one or more metric-generic anomalous data points utilizing a machine learning-based multivariate anomaly detector trained to identify structural anomalies across the set of two or more metrics;
to identify a given one of the one or more metric-specific anomalous data points for the latency metric which corresponds to one of the one or more metric-generic anomalous data points;
to determine whether the given metric-specific anomalous data point for the latency metric represents a performance issue for the storage system based at least in part on whether there are any co-occurring metric-specific anomalous data points for at least one of the one or more additional metrics; and
responsive to determining that the given metric-specific anomalous data point for the latency metric represents a performance issue for the storage system, to initiate remediation of the performance issue for the storage system.

16. The computer program product of claim 15 wherein determining whether the given metric-specific anomalous data point for the latency metric represents a performance issue for the storage system comprises generating a ranking of co-occurring metric-specific anomalous data points for the one or more additional metrics, the ranking being based on predicted impact of the one or more additional metrics on latency of the storage system.

17. The computer program product of claim 16 wherein determining whether the given metric-specific anomalous data point for the latency metric represents a performance issue for the storage system comprises utilizing the ranking of the co-occurring metric-specific anomalous data points for performing root cause analysis of the given metric-specific anomalous data point for the latency metric.

18. A method comprising:
obtaining monitoring data for a storage system, the monitoring data comprising telemetry data for a set of two or more metrics, the set of two or more metrics including a latency metric and one or more additional metrics;
determining, for each metric in the set of two or more metrics, one or more metric-specific anomalous data points utilizing a machine learning-based univariate anomaly detector trained utilizing historical telemetry data for that metric;
determining, for the set of two or more metrics collectively, one or more metric-generic anomalous data points utilizing a machine learning-based multivariate anomaly detector trained to identify structural anomalies across the set of two or more metrics;
identifying a given one of the one or more metric-specific anomalous data points for the latency metric which corresponds to one of the one or more metric-generic anomalous data points;
determining whether the given metric-specific anomalous data point for the latency metric represents a performance issue for the storage system based at least in part on whether there are any co-occurring metric-specific anomalous data points for at least one of the one or more additional metrics; and
responsive to determining that the given metric-specific anomalous data point for the latency metric represents a performance issue for the storage system, initiating remediation of the performance issue for the storage system;
wherein the method is performed by at least one processing device comprising a processor coupled to a memory.

19. The method of claim 18 wherein determining whether the given metric-specific anomalous data point for the latency metric represents a performance issue for the storage system comprises generating a ranking of co-occurring metric-specific anomalous data points for the one or more additional metrics, the ranking being based on predicted impact of the one or more additional metrics on latency of the storage system.

20. The method of claim 19 wherein determining whether the given metric-specific anomalous data point for the latency metric represents a performance issue for the storage system comprises utilizing the ranking of the co-occurring metric-specific anomalous data points for performing root cause analysis of the given metric-specific anomalous data point for the latency metric.
